(19) United States
(12) Patent Application Publication
(10) Pub. No.: US 2006/0206813 A1
(43) Pub. Date: Sep. 14, 2006

(54) System and method for management of the production of printed material

(76) Inventor: Peter Kassan, Croton-On-Hudson, NY (US)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 11/369,969

(22) Filed: Mar. 8, 2006

Related U.S. Application Data
(60) Provisional application No. 60/659,627, filed on Mar. 8, 2005.
(60) Provisional application No. 60/664,159, filed on Mar. 22, 2005.

(51) Int. Cl. G06F 17/00; G06F 3/12

(52) U.S. Cl. 715/530; 715/500; 358/1.15

(57) ABSTRACT

The present invention ensures that content provided in formatted print pages is current, and can provide a convenient user interface to identify portions of a display screen to monitor for changes in content. Alternatively, the invention can monitor data storage locations for changes in content, or be informed by a contact provider of changes in content. Moreover, the invention preferably registers a flag or other setting when a change is recognized, and can further automatically take action based upon an evaluation of the change. Alternatively, a website (or other course material provided on a communication network) is automatically displayed for a user to determine whether any actions are warranted. Thus, changes in content are, preferably, regularly monitored and registered.

### CROSS REFERENCE TO RELATED APPLICATIONS

The present invention is based on and claims priority to U.S. Patent Application Ser. Nos. 60/659,627, filed Mar. 8, 2005, entitled SYSTEM AND METHOD FOR PRODUCING FORMATTED PRINT PAGES (VIII); 60/664,159, filed Mar. 22, 2005, entitled SYSTEM AND METHOD FOR PRODUCING FORMATTED PRINT PAGES (IX); Ser. No. 11/283,894, filed Nov. 11, 2005, entitled A SYSTEM AND METHOD FOR MANAGEMENT OF THE PRODUCTION OF PRINTED MATERIAL which is a continuation in part of Ser. No. 11/204,059, filed Aug. 15, 2005, entitled SYSTEM AND METHOD FOR MANAGING COPYRIGHT INFORMATION OF ELECTRONIC CONTENT which is a continuation in part of U.S. patent application Ser. No. 11/199,358 filed Aug. 8, 2005, entitled SYSTEM AND METHOD FOR VIRTUAL PRINT DEVICES FOR COMMAND IMPLEMENTATION, which is a continuation-in-part of U.S. patent application Ser. No. 11/193,716 filed Jul. 29, 2005, entitled IMPROVED SYSTEM AND METHOD FOR PROVIDING FORMATTED PRINT PAGES, which is a continuation-in-part of Ser. No. 10/671,194 filed Sep. 25, 2003, entitled SYSTEM FOR PRODUCING ONLINE CONTENT FROM WEB SITES ON DEMAND, the entire contents of all of which are hereby incorporated herein by reference.

### FIELD OF THE INVENTION

The present invention relates generally to electronic content stored over a network, and more particularly, to using electronically stored content stored on a network that is current and providing formatted print pages of such content.

### BACKGROUND OF THE INVENTION

Many sites on the World Wide Web of the Internet (hereinafter, “web sites”) are magazine-like in format, or present a number of magazine-like sections. In many cases, the site, or specific magazine-like section, is often formatted in columns and/or rows of simulated or virtual “pages” and includes photographs or pieces of art. These specifically formatted elements of these web pages are meant to be viewed as a whole. With respect to photographs, small “thumbnail” images are typically provided that cause larger, more viewable images to be displayed, when selected via a click of a mouse or other pointing device. In other cases, web sites are not magazine-like at all, and consist entirely of text.

It is well-established that people prefer to read documents on physical paper rather than on a computer display (see, for example, The Myth of the Paperless Office, by Abigail J. Sellen and Richard H. R. Harper [MIT Press, 2001]). It is also well-established that people like to view, collect and own art, graphics, and photography on paper or similar medium, such as books and magazines. Printing web site “pages” that comprise art, graphics, and photography, for example, on a user's home printer or even lower speed, lower cost corporate network printers, usually yields unsatisfactory results despite a similarity between “pages” on Internet web sites and physical pages in a book or magazine. Even text-based web sites that are printed on a home printer or lower cost corporate printer are typically unsatisfactory as people prefer printed text in, for example, a bound volume.

A typical cause for such unsatisfactory results is that web pages are usually not formatted to be reproduced on standard-sized printer pages, e.g., 8½ by 11 inch paper. For example, printed web sites frequently run onto subsequent, partially filled pages. Other problems include partial or incomplete printing, and printing of undesired content, such as programming code or coded representations of objects. Internet web sites rarely, if ever, resize oversized images for a user's printing, so that the images typically print on successive pages or are truncated. Although a skilled user can often find a way to format a printed web page properly (such as by printing only a selected “frame”, printing only selected material, or sizing an image to fit the paper), most users do not know how to do so, or find it too much trouble to do so, particularly for large numbers of pages. Moreover, navigation links and other material that is often included at the bottom of each web page are typically repeated at the end of each section when it is physically printed.

Furthermore, many printing devices do not accommodate double-sided printing. Although some printing devices have double-sided capability, users often forget or don't know how to set their printing device to do so. Some printing devices, for example many kinds of laser printers, also do not print in color, although the majority of web sites use color. Further, optimal results for art, graphics, and photography web pages are only achieved by using special, expensive paper. Moreover, photo-quality paper is rarely distributed with a double-sided capacity.

Even if a user has the appropriate printing device, paper, and skills to format and print web pages such that they are well laid-out on both sides of a set of pages of appropriate quality, the print jobs are typically output on unbound single sheets of paper and are also, therefore, unsatisfactory.

Some web sites provide portions of content that are available in the PORTABLE DOCUMENT FORMAT (“PDF”), as developed by ADOBE SYSTEMS. The PDF versions can be printed on a user's home computer printer. However, these printed documents suffer from all of the limitations described above with respect to loose sheets of paper that are, typically, not designed for high-quality images. Moreover, PDF documents offered by various web sites usually provide content in conjunction with a web site, rather than providing content that is displayed in the web site. For example, technical manuals and journals, white papers and sales brochures comprise typical PDF documents that are available on Internet web sites. One skilled in the art will recognize that it is possible to produce a PDF document comprising content in a web site. However, printing such a PDF results in many if not all of the same problems identified above.

In summary, therefore, a “web page” that is printed, for example, by using native web browser functionality, is not a “formatted print page.” A collection or a series of typical web pages do not naturally or logically easily translate to a correct sequence of printed pages as they appear in a typical publication, such as in a book or a magazine. As used herein, “formatted print pages” refer, generally, to pages that comprise text, graphics and/or images that are printed on a particular paper size, in a particular format and layout, using specific colors or print technology with sequential print pages that can be placed on the same side of sequential printed pages or in a double-sided arrangement. Typically, the resolution of formatted print pages is 70 times higher than that displayed in typical web pages. As used herein, the term “formatted print pages” refers, generally, to printed content, at least some of which is identified in an Internet web site and is printed including characteristics, as described herein. Formatted print pages have a much more attractive, professional form and appearance over prior art forms, substantially as described above. Furthermore, a typical web page can be designed in practically unlimited width and length. Typical web browser software provides horizontal and vertical scroll bars automatically while displaying a web site that extend horizontally and/or vertically beyond the viewable region of a display screen. These, and other known variables affecting the layout of a web page, contribute to fundamental differences between a web page and a formatted print page.

Also as used herein, “formatted print pages” refer to printed pages that meet at least some criteria set forth above, such that the web site content can be utilized by a printing company or other production entity such as in-house corporate printing facilities to create print media, including web site content that is combinable or that can be bound into a book, a magazine or the like.

A drawback of the prior art ensues from the fact that users cannot obtain printed web pages that are bound in a book-like or magazine-like fashion. Web sites may purport to provide a user with a printable version of web pages (so-called “printer friendly” versions), but do so without any specific knowledge of the printing equipment on which such pages are to be printed, resulting in all of the foregoing drawbacks of the prior art. In other words, a web host provides web pages without any ability and without including any special software that assures that the user will obtain a pre-defined page layout and sequencing that will be standardized to the particular web pages being displayed.

Many kinds of systems exist for binding sheets of paper, such as hard or soft-cover loose-leaf binders and plastic binding strips that are slid along the left margin of a set of pages, staples and the like. However, these systems are never as satisfactory as saddle-stitched or perfect bound books or magazines for several reasons. For example, the holes necessary to place pages into loose-leaf binders may overlay text or an image of the page. Also, loose-leaf binders are often bulky and do not file well on bookshelves since they are usually not rectangular, but triangular solids. Furthermore, binding strips often obscure parts of the text or image area of the pages and make the resulting collection of papers impossible to lay flat on a horizontal surface, such as a desk.

Stapling materials also results in similar defects as described above with respect to binding strips. Stapling usually works well only with a relatively small number of pages, unless a heavy-duty stapler (not usually an item of home use) is used. Stapling also often damages pages, which are then prone to tearing.

Referring to the drawings in which like reference designators refer to like elements, FIG. 1 shows a prior art hardware arrangement for viewing, reviewing and outputting internet web site content. As shown in FIG. 1, an information processor with web server 2 provides electronic content to a user terminal 4 that communicates with the information processor 2 via communication network 16. The user terminal preferably employs software that enables a communication session to be established between the user terminal 4 and the information processor with web server 2. Preferably, the information processor 2 employs software enabling a communication session, for example an HTTP session, to be established between the user terminal 4 and the web server 2. Information processor 2 typically provides content over the Internet which can be received by user terminal 4. Content includes, for example, text, graphics, pictorial, audio and video material.

Also as shown in FIG. 1, an output printer 7 is preferably controlled by user terminal 4 to provide printed output of content. For example, after a person views content on user terminal 4 using typical web browser software, the person selects an option to print the content on printer 7. The printed version, unfortunately, is typically unsatisfactory for the reasons set forth above.

There is a need in the industry to provide printed versions of web site content, as a whole or in part, as formatted print pages.

Systems for detecting changes in web sites or other materials are known. For example, commercial software applications that perform regression testing are available that recognize and report changes made to data and/or content. A drawback of the prior art is that users cannot obtain updated printed pages when changes are made to the content of the website. Therefore, there is a need in the industry to provide printed versions of web site content as formatted print pages, in which the content is current. The technical problem associated with this need is how to identify the information that is significant. This poses a further technical problem of how to determine whether any changes to web site content warrant further action, such as providing updated formatted print pages.

### SUMMARY OF THE INVENTION

In the present invention, functionality disclosed in U.S. patent application Ser. No. 10/671,194, and continuations thereof, is coupled with a system and method for detecting changes in web sites and other material to ensure that content provided in formatted print pages is current. Many people have a need or desire for a formal, printed hard copy of electronic content they view over a communication network, such as the Internet. The present invention discloses a system and method for providing formatted print pages containing content stored over a communication network. For example, a person operates a known Internet web browser software to “visit” an Internet web site, and orders a printed and bound copy of content selected by the visitor. The invention includes modules that operate to take, process and complete orders, such that the visitor receives (e.g., by mail) formatted print pages of the content he selected. The visitor is preferably provided an option to receive content in formatted print pages regularly over time as content is updated and/or changed (e.g., a subscription).

As used herein, the term “content provider” refers, generally, to a source of electronically stored information that makes the content available over a communication network, such as the Internet. For example, an Internet web site that provides content directed to ornithology. Reports on various bird species are frequently posted on the web site, and subsequently removed when new reports are posted. In accordance with the present invention, changes in electronic content are registered in a database and operators of the present invention can be alerted to these changes. Thus, after a new report on a bird is posted, the present invention preferably registers the change and provides a code that indicates that a change has occurred.

When a change is made to an Internet web site page, for example, because new images are posted, the present invention preferably recognizes that the change has occurred and provides a code that represents the degree of the change, for example, either a qualitative or quantitative degree. For example, the invention recognizes that many pixels in an area of a web site where an image is displayed have changed and makes a determination that a new picture has been posted. Alternatively, the present invention recognizes that a minor change has been made and the present invention determines and/or indicates that the change is relatively minor. Changes to content are evaluated and some appropriate action can be taken. For example, a new copy of formatted print pages can be ordered based on the type of the changes and provided to the visitor (subscriber). Preferably, the Internet web site includes content that is used to generate formatted print pages.

Various activities may take place in response to changes in electronically stored content, such as tracking content changes over time and providing formatted print pages after a predefined quantitative (or qualitative) degree of changes have taken place. Alternatively, if a significant change has occurred, an order for formatted print pages may be manually or automatically processed and fulfilled.

The present invention is further directed to a system for providing formatted print pages that comprise content represented in a web site. The system comprises add-in software operable with the web site that enables a visitor of the web site to submit an electronic request for the formatted print pages. The system includes a request receiving module that receives the electronic request over a communication network, and a request processing module that processes the contents of the electronic request and provides electronic production information that provides instructions for fulfilling the electronic request. The system also includes a transmitting module that transmits the electronic production information to a fulfillment facility operable to provide the formatted print pages corresponding with the electronic production information, and a formatted print pages delivery module operable to provide to the visitor the formatted print pages.

Other features and advantages of the present invention will become apparent from the following description of the invention which refers to the accompanying drawings.

### BRIEF DESCRIPTION OF THE DRAWINGS

For the purposes of illustrating the invention, there is shown in the drawings a form which is presently preferred, it being understood, however, that the invention is not limited to the precise arrangements and instrumentalities shown. The features and advantages of the present invention will become apparent from the following description of the invention that refers to the accompanying drawings, in which:

FIG. 1 shows a prior art hardware arrangement for viewing, reviewing and outputting internet web site content;

FIG. 2 shows an example hardware arrangement of a preferred embodiment of the present invention;

FIG. 3 is a block diagram illustrating the functional elements in an example information processor;

FIG. 4 is a flowchart illustrating the method of the present invention.

FIG. 5 shows an example system of a preferred embodiment of the present invention.

### DETAILED DESCRIPTION OF THE INVENTION

The present invention ensures that content provided in formatted print pages is current and can provide a convenient user interface to identify portions of a display screen to monitor for changes in content. Providing current content allows the user to stay up-to-date and, when automated or semi-automated, reduces workflow. As used herein, the terms “visitor” and/or “visitor terminal” refer, generally, to a person and/or device operated by a person that establishes a communication session over a network with another device.

More particularly, an on-line service provider, operating an information processor and referred to herein, generally, as a “production information processor,” preferably provides software for proprietors of web sites who are desirous to provide formatted print pages of content displayed in their web sites, or content related thereto. Similarly, the production information processor can be hosted internally on a corporation's intranet. In addition to providing the services for creating formatted print pages, the internal production information processor can also be used to monitor the website content of the formatted print pages to ensure that the content is current. The source of the information contained in the print jobs can either be from the external Internet or from the internal intranet. The production information processor can be used to provide only the updated website content, or only for the creation of the formatted print pages or for both.

In a preferred embodiment, software incorporating the present invention is incorporated into a web site, either internal or external, referred to herein as a “information content web site” A visitor to the information content web site can request at least a portion of the web site to be reproduced as one or more formatted print page(s). The production information processor preferably uses information received in a request to provide formatted print pages. The production information processor contributes to the production of the formatted print pages in accordance with predetermined styles and layouts.

The software provided by the production information processor (hereinafter, the “add-in software”) is used in connection with one or more software programs that generate an information content web site. The add-in software preferably allows visitors to the information content web site to order formatted print pages comprising the content provided in or related to the information content web site. The add-in software functions to transmit information about an order for formatted print pages to one or more production information processor.

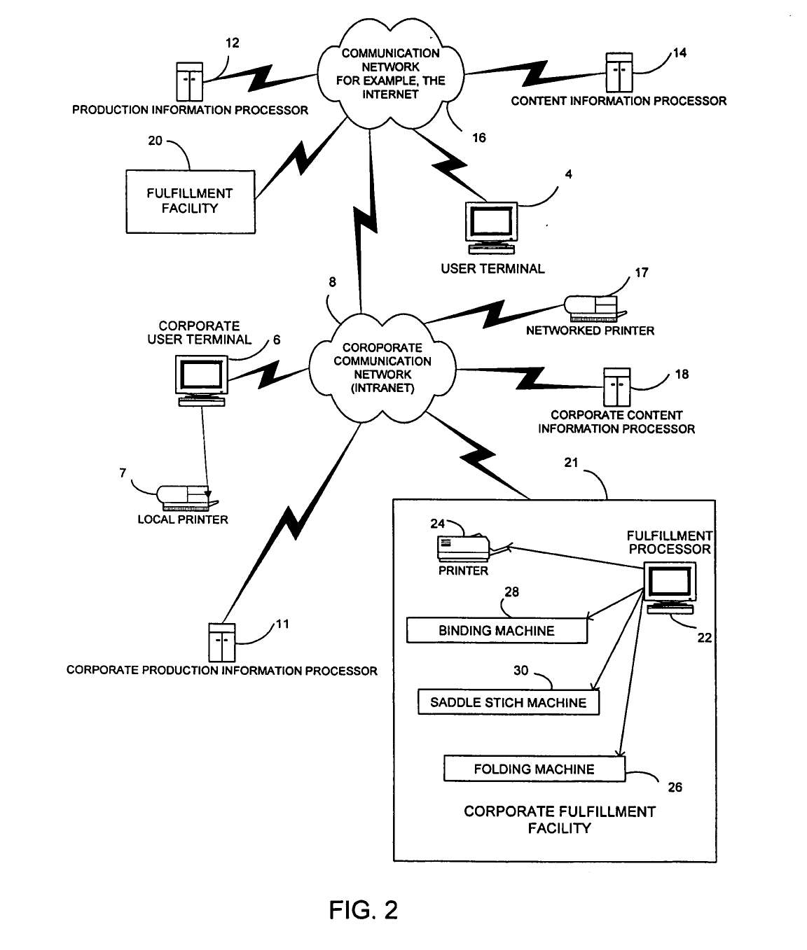

FIG. 2 shows an example of a preferred embodiment of the present invention, including a hardware arrangement of system 10 for controlling user requested print jobs and for providing formatted print pages comprising web site content. System 10 comprises at least one production information processor 12 coupled to a publicly available communication network 16, such as the Internet 16. System 10 further includes at least one corporate production information processor 13 coupled to a corporate network 15, an intranet. At least one information content processor 14 is coupled to communication network 16. The content information processor 14 preferably provides an Internet web site 15 that includes content for visitors.

Also as shown in FIG. 2, a fulfillment facility 20 communicates with at least the production information processor 12 and receives instructions with respect to a request for formatted print pages. Although the embodiment shown in FIG. 2 identifies the fulfillment facility 20 separate from the production information processor 12, the fulfillment facility 20 can be under the direct control of the proprietor of the production information processor 12. All of the elements described below (22, 24, 28, 30 and 26) that are contained in corporate fulfillment facility 21 are also preferably contained in fulfillment facility 20. The functions of these elements are the same in fulfillment facility 20 as they are in corporate fulfillment facility 21 as these two facilities are substantially identical, one being hosted and maintained with the organization, 21, and one being a vendor operated, external, commercial facility, 20.

In the example shown in FIG. 2, corporate fulfillment facility 21 preferably includes a formatted print page output printer 24. In addition to the formatted print page output printer 24, one or more other devices are preferably provided and used in accordance with the present invention. For example, corporate fulfillment facility 21 employs a binding machine 28 to combine individual sheets. Further, a saddle stitch machine 30 may be included to provide a professional appearance for the printed output. Further, a folding machine 26 may be employed by the fulfillment facility 20 in order to prepare signatures, i.e., sets of one or more sheets for binding. As shown in FIG. 2, the output related devices, including, the folding machine 26, binding machine 28, and saddle stitch machine 30 are presented as separate and apart from the formatted print page output printer 24. Of course, one skilled in the art will recognize that two or more of these devices may be integrated into a single device. For example, the formatted print page output printer 24 may have a series of attachments that comprise a folding machine and a binding machine. The folding machine and binding machine can operate to produce one or more signatures.

The corporate fulfillment facility 21 is coupled to the corporate network 8. Corporate fulfillment facility is used to support the special printing needs of the corporate users 6. In addition to the local printer 7 attached to a corporate user's workstation 6, and the printing devices included in the corporate fulfillment facility 16, a plurality of other network printers 17 are attached to the corporate network 8. The user 6 has preferably has access and rights to print to one or more of these network printers 17.

Production information processors 11 and 12 preferably includes all databases necessary to support the formatted print pages functions of the present invention. However, it is contemplated that production information processors 11 and 12 can access any required database via communication networks 8 or 16 or any other communication network to which production information processors 11 and 12 may be coupled. Communication network 16 is preferably a global public communication network such as the Internet, but can also be a wide area network (WAN), local area network (LAN), or other network that enables two or more computers to communicate with each other.

In the preferred embodiment, production information processors 11 and 12 and content information processor 14 are any devices that are capable of sending and receiving data across communication networks 8 and 16, e.g., mainframe computers, mini computers, personal computers, laptop computers, a personal digital assistants (PDA) and Internet access devices such as Web TV. In addition, production information processors 11 and 12 and content information processor 14 are preferably equipped with a web browser, such as MICROSOFT INTERNET EXPLORER, NETSCAPE NAVIGATOR and the like. Production information processors 11 and 12 and content information processor 14 are coupled to communication networks 8 and 16 using any known data communication networking technology.

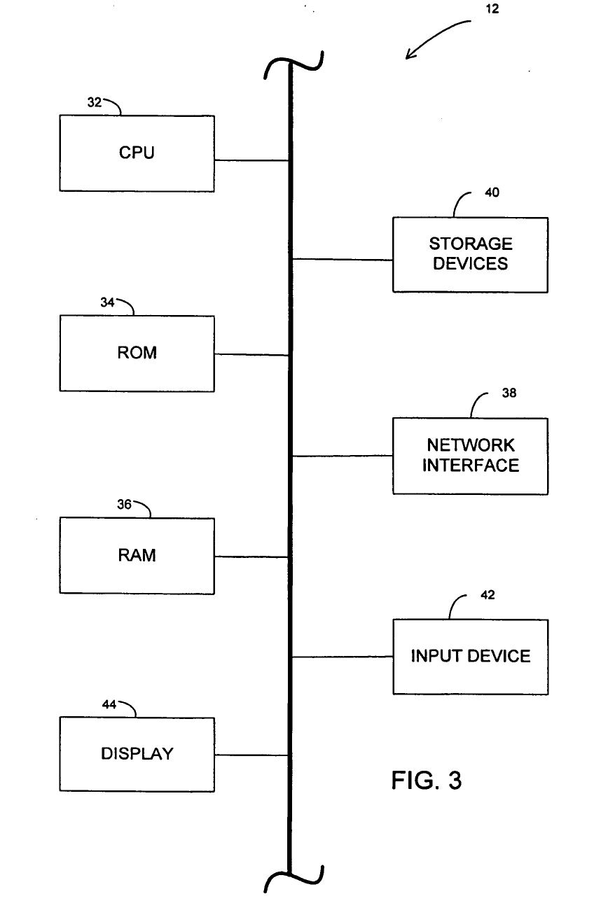

As shown in FIG. 3, the functional elements of a typical production information processors 11 and 12 are shown, and include one or more central processing units (CPU) 32 used to execute software code and control the operation of production information processors 1 and 12, read-only memory (ROM) 34, random access memory (RAM) 36, one or more network interfaces 38 to transmit and receive data to and from other computing devices across a communication network, storage devices 40 such as a hard disk drive, floppy disk drive, tape drive, CD ROM or DVD for storing program code databases and application data, one or more input devices 42 such as a keyboard, mouse, track ball, microphone and the like, and a display 44.

The various components of production information processors 11 and 12 need not be physically contained within the same chassis or even located in a single location. For example, storage device 40 may be located at a site which is remote from the remaining elements of production information processor 12, and may even be connected to CPU 32 across communication network 16 via network interface 38. Production information processors 11 and 12 preferably includes a memory equipped with sufficient storage to provide the necessary databases, forums, and other community services as well as acting as a web server for communicating hypertext markup language (HTML), Java applets, Active-X control programs or the like to content information processors 14. Production information processors 11 and 12 are arranged with components, for example, those shown in FIG. 3, suitable for the expected operating environment of production information processors 11 and 12. The CPU(S) 32, network interface(s) 38 and memory and storage devices are selected to ensure that capacities are arranged to accommodate expected demand.

As used herein, the terms “link” and “hyperlink” refer to a selectable connection from one or more words, pictures or other information objects to others in which the selectable connection is presented within the web browser. The information object can include sound and/or motion video. Selection is typically made by “clicking” on the link using an input device such as a mouse, track ball, touch screen and the like. Of course, one of ordinary skill in the art will appreciate that any method by which an object presented on the screen can be selected is sufficient.

The functional elements of production information processors 11 and 12 shown in FIG. 3 are of the same categories of functional elements present in content information processors 14, corporate user workstation 6 and fulfillment facility processor 22. However, not all elements need be present in the content information processor 14, corporate user workstation 6 or fulfillment facility processor 22. For example, storage devices, in the case of PDA's, and the capacities of the various elements are arranged to accommodate the expected user demand. For example, CPU 32 in content information processor 14 may be a smaller capacity CPU than the CPU present in the production information processors 11 and 12. Similarly, it is likely that the production information processors 11 and 12 will include storage devices of a much higher capacity than storage devices present in content information processor 14. Of course, one of ordinary skill in the art will understand that the capabilities of the functional elements can be adjusted as needed.

The nature of the invention is such that one skilled in the art of writing computer executable code (i.e., software) can implement the functions described herein using one or more of a combination of popular computer programming languages and developing environments including, but not limited to, C, C++, Visual Basic, JAVA, HTML, XML, ACTIVE SERVER PAGES, JAVA server pages, servlets, and a plurality web site development applications.

Although portions of the present invention are described by way of example herein and in terms of a web-based system using web browsers and a web site server, system 10 is not limited to such a configuration. It is contemplated that system 10 is arranged such that content information processor 14 communicates with and displays data received from production information processor 12 using any known communication and display method, for example, using a non-Internet browser WINDOWS viewer coupled with a local area network protocol such as the Internet Packet Exchange (IPX), dial-up, third-party, private network or a value added network (VAN).

It is further contemplated that any suitable operating system can be used on production information processors 11 12 and content information processor 14, for example, DOS, WINDOWS 3.x, WINDOWS 95, WINDOWS 98, WINDOWS NT, WINDOWS 2000, WINDOWS ME, WINDOWS CE, WINDOWS POCKET PC, WINDOWS XP, MAC OS, UNIX, LINUX, PALM OS, POCKET PC and any other suitable operating system.

As used herein, references to displaying data on production information processors 11 and 12 and content information processor 14 regard the process of communicating data across communication network 16 and processing the data such that the data is viewed on a corporate user workstation 6, for example by using a web browser and the like. As is common with web browsing software, the corporate user workstation 6 is capable of presenting sites within the system 10 such that a user can proceed from site to site within the system by selecting a desired link.

Therefore, each user's experience with system 10 is based on the order with which he/she progresses through the display screens. Graphic controls are preferably available in the display screens and modules to initiate data processes, and to provide convenient navigation between the display screens and modules of system 10. In other words, because the system is not completely hierarchical in its arrangement of display screens, users can proceed from area to area without the need to “backtrack” through a series of display screens. For that reason, and unless explicitly stated otherwise, the following discussion is not intended to represent any sequential operation steps, but rather to illustrate the components of system 10.

As used herein, the term “proprietor” refers, generally, to an owner/operator of a device, such as an information processor 12 or content information processor 14. A proprietor does not have to be in physical proximity with the device in order to exercise control over it. Also as used herein, a proprietor refers to a party who exercises control over the content and features provided on a web site and/or information processor.

As noted above, production information processor 12 preferably provides a production web site to which visitors can connect. Production web site is available to anyone who is able to establish a communication session with the production information processor 12. Once the session is established, the visitor can view content regarding services provided by the production information processor 12. Such content is considered herein, generally, as “public” content because access thereto is unrestricted. Production web site preferably also includes content which is restricted to authorized personnel, for example, registered customers who have contracted for the services provided by the proprietor of the production web site 13. Such content is referred to herein, generally, as “private” content. In one embodiment of the present invention, production information processor 12 provides corporate users (for example using corporate user terminal 6) with access to specialized services contracted for and customized to the user's corporation.

The methods and processes by which a corporate user, using a corporate user terminal 6 can view order and print formatted print pages from content information processor 14, production information processor 12, corporate production information processor 11, corporate fulfillment facility 21 and fulfillment facility 20 is fully described in co-pending application Ser. No. 10/671,194 and shall not be reiterated herein.

The system and process for using current content that is posted on a network and providing formatted print pages of electronically stored content that is current will now be described.

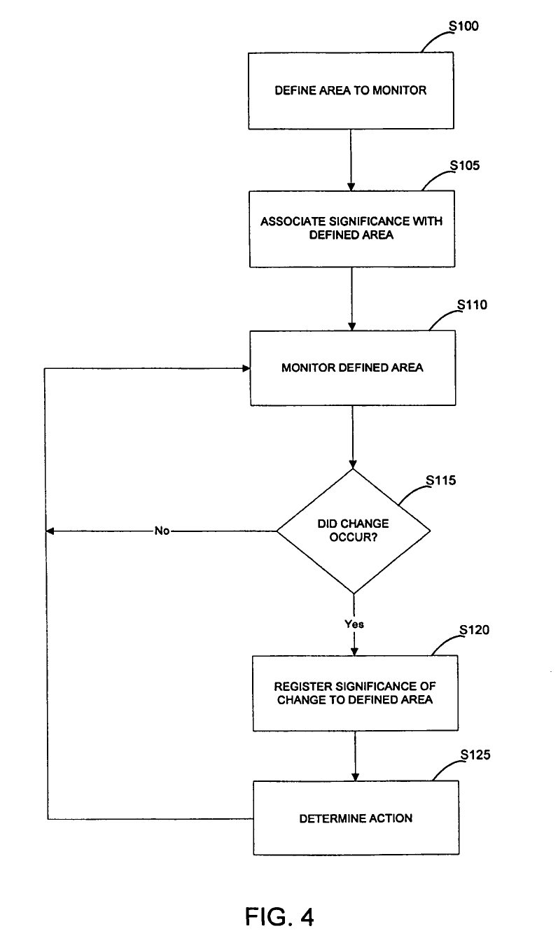

The flowchart illustrated in FIG. 4 illustrates the process by which current content is provided. At a first level, at step S100, a convenient graphical user interface is provided that includes controls for selecting and defining a portion of display to determine and evaluate changes in content. In a preferred embodiment, this user interface is provided either on the content information processor (14, 18) or the production information processor (11,12). For example, a drawing-like tool is provided that, when selected, defines an area of displayed website content, such as a rectangular area. In a preferred embodiment, the user interface preferably allows both inclusion and exclusion of areas, so that the user can identify “the whole page except this area” or “only this area” or even “only this area except for this part of that area.” In addition, entire webpages, websites, and subtrees of a hierarchical set may be excluded. One skilled in the art recognizes that regression test software typically supports such inclusion and exclusion. Identification of the defined areas is stored in any convenient location as known by those skilled in the art. The user interface may be provided in custom software application, a customized web browser application, or may be provided via add-in software operable with existing software.

In step S105, the process of the present invention enables the user to assign a significance of the areas defined in step S100. Specifically, the user can associate relative values to represent the significance of any change that occurs in the defined areas. For example, an area of display where the time and date are displayed will change frequently and the significance of such changes, in accordance with the present invention may be relatively low or entirely unimportant. Alternatively, changes to any content that is displayed in an area defined as a location where a price for an item is displayed represents a very significant change. The decision to take various forms of action can be dependent, at least in part, upon the significance values associated with various predefined areas of a display screen. Significance of the defined areas is stored in any convenient location as known by those skilled in the art.

As defined herein, a “user” refers to at least one of a plurality of parties, depending upon the context. For example, one user is a web site provider (or representative of a web site provider). In this example, the user is associated with the web site itself, rather than someone visiting the web site, via, for example, typical web browsing software. Alternatively, a user refers to a visitor of a website. Further, the user can be the operator of the production information processor (11, 12) as described above.

In step S110, in one embodiment of the present invention, the defined areas of the content are regularly and preferably automatically (or substantially automatically) monitored in order to determine if changes have occurred since the last monitoring of the particular website content.

In an alternative embodiment of step S110 of the present invention, a user (recipient of formatted print pages) submits an order for formatted print pages and an active check of the content occurs at that time. Rather than waiting for the next period at which the content of the requested site is regularly monitored, the present invention actively examines the requested content in order to determine if changes have occurred.

After the present invention has been cued to monitor particular content (whether automatically or manually) in accordance with step 110, the present invention, in step S115 determines whether a change has occurred. The defined areas of content previously defined by a user in step S100 are evaluated (preferably regularly or over time) to determine whether changes in content that are displayed in the defined area have occurred. Preferably, some form of regression testing takes place (e.g., resulting from a “screen scraping” procedure) as at least part of the evaluation.)

For example, in a preferred embodiment, a predefined portion of the display (step S100) is evaluated, pixel by pixel, and a has total of the bytes representing the pixels is calculated in a mathematical summary. An algorithm is used to compare the current hash total with a previously calculated has total to determine whether a significant change has taken place in the defined area. Thus, the present invention, preferably, does not store an image of a web site itself thus reducing the storage requirements of the present invention. Of course, one skilled in the art will recognize that, in an alternative embodiment, images of web sites (or perhaps, a portion thereof) can be made and stored in order to monitor (step S110) and determine the degree of changes in content (step S120), without departing from the teachings therein.

In an alternative embodiment, specific locations on a server or other computer system where content is stored are evaluated. Instead of the graphical approach described above in which portions of a display are evaluated (pixel by pixel) for changes in content, storage locations on a computer system, (e.g., paths, folders and/or directory locations) are evaluated for changes in content. Thus, one or more storage locations provided on one or more computer systems are monitored for changes to content (e.g. text, images) stored therein, and the present invention registers when such changes occur. For example, changes to text can be compared on the basis of the bytes that represent them. Preferably, the evaluation is insensitive to changes in typeface or font, which may or may not be significant. This functionality is provided to someone associated with the customer web site, and, typically, this is a one-time operation, unless pages associated with a printed product are added or removed from the customer web site, or the customer web site is restructured in some way.

In another alternative, or in partial combination with the two alternatives described above, an automated process, such as a software robot (“softbot” or “bot”) automatically establishes a communication session with a content provider and determines whether (and what kind) of changes are made to content. In one embodiment, after a communication session is established, an evaluation is automatically made of content stored databases to determine whether changes have occurred. In case content has changed, a “dirty” flag is set for each content item, in case something relevant to that item changes. The flag is used to determine whether additional action should take place, such as providing updated formatted print pages to a user.

In step S120, after changes are made to content (including, for example, new products, pages within products, and predefined areas with web site pages in which changes to content have been made), a “flag” is preferably set indicating that changes have been detected. Appropriate action will be taken in step S125 in accordance with the meaning of the flag. For example, in a preferred embodiment, a flag representing an insignificant change in content will not trigger an updates to a press-ready file. Alternatively, a flag representing a significant change will trigger an update to a press-ready file. Preferably, existing press-ready files are not used for producing formatted print pages until a flag is generated, and the press-ready files are appropriately updated in accordance with the meaning of the flag.

In step S120, preferably, the invention recognizes and, if necessary, compensates for content that dynamically changes, such as animations (FLASH animations, animated GIF files, or the like). The present invention recognizes the significance of such content and registers whether some activity may be required in response thereto.

In the previous discussion, the user specifying the areas to monitor is associated with the web site itself, i.e., he or she is the web site customer. Alternatively, the user who review changed content is preferably associated with the production information processor 12. In the typical workflow, the person reviewing the change—which is on-going—is typically not the same person who is setting up the monitoring, which is typically a one-time operation.

Moreover, after a change has been registered (step 115), and the significance of the change is determined (step 120), the present invention makes a determination whether to take any further action in step S125. In other words, the present invention operates to signal that a change in content has occurred, and provides a convenient way to review details of the change, for example, to make corresponding updates to electronic files and/or databases. For example, after a change has been registered, the web site is automatically displayed so that a determination can be made whether to take further action.

In a preferred embodiment, changes are not ordered until a web site visitor is supposed to receive a printed product. Thus, the operator of the production information processor 11, 12 can, if he or she chooses, wait until the order is received to be signaled that a new (i.e. press-ready) version of the item has been produced, or can make the appropriate changes ahead of time. Alternatively, if the web site visitor has a subscription and the change is significant as determined in step S120, the change itself will signal that a new product has to be produced. If the entire process is automated, the press-ready version of the file is kept up-to-date because the change has occurred, and then depending on whether there are subscription or the production of the printed product is on-demand, either something is printed or not.

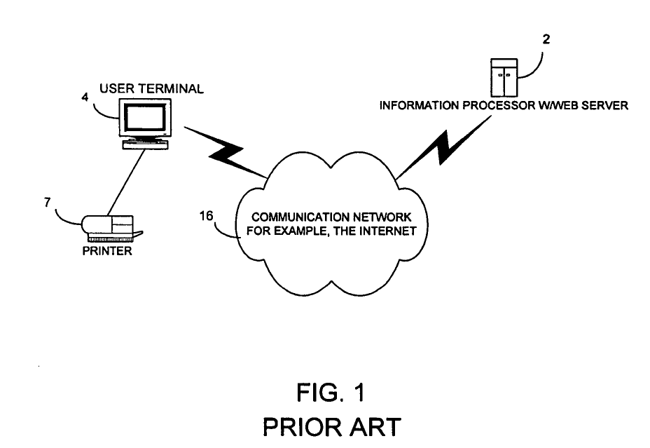

If further action in step 125 requires formatted print pages, then the printing can be directed to the individual's personal printer 7 (FIG. 1), to any printer attached to the network (e.g., networked printer 17), to an in-house print facility (e.g., corporate production information processor 11 and corporate fulfillment facility 16, FIG. 1), or to a commercial printing facility (e.g., production information processor 11 and fulfillment facility 20). As described in co-pending application Ser. No. 10/671,194, the corporate production information processor 11 and corporate fulfillment facility 16 are capable of generating professional quality print materials such as saddle stitched or perfect bound output.

Preferably, an email or other electronic acknowledgment indicating receipt of an order for formatted print pages is transmitted from the production information processor 11 or 12 to the person placing the order, for example, upon a receipt and when the formatted print pages are prepared.

The present invention can be implemented in various ways. In one embodiment, a content provider provides information that identifies changes to content that are made. In this way, the content provider is responsible for monitoring when content changes. In an alternative embodiment, the present invention automatically (or substantially automatically) determines the degree to which content has changed, without the aid of a content provider. The latter embodiment can be further provided in various ways. For example (as noted above), a hash total can be calculated and stored for future reference. Alternatively, an image of a website can be stored in a repository provided by the present invention and referenced (manually by a person or automatically by a device or module) for determining whether changes in content have occurred.

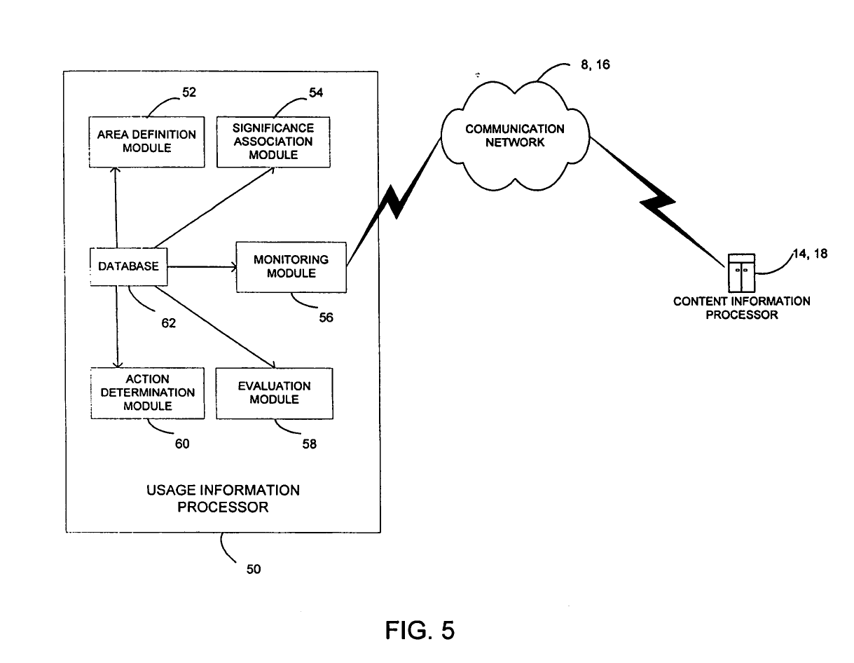

FIG. 5 shows an example of a preferred embodiment of the system of the present invention, including a hardware arrangement of system 100 for using current content that is posted on a network. System 100 comprises at least one content information processor 14, 18 coupled to a communication network 8, 16. The content information processor 14, 18 preferably provides any Internet website that includes content for visitors. The communication network is a publicly available network 16, such as the internet 16, or a corporate information network 8, such as an intranet 8. System 100 further includes at least one usage information processor 50 coupled to a communication network 8, 16. The usage information processor 50 supports the needs of users who wish to obtain current web site content. A fulfillment facility 20, 21 communicates with at least the usage information processor 50 and/or a production information processor 11,12 and receives instructions with respect to a request for formatted printed pages.

In the preferred embodiment, the usage information processor 50 is any device that is capable of sending and receiving data across communication networks 8 and 16, e.g., mainframe computers, mini computers, personal computers, laptop computers, a personal digital assistants (PDA) and Internet access devices such as Web TV. In addition, the usage information processor 50 is preferably equipped with a web browser, such as MICROSOFT INTERNET EXPLORER, NETSCAPE NAVIGATOR and the like. The usage information processor 50 is coupled to communication networks 8 and 16 using any known data communication networking technology.

In the example shown in FIG. 5, the usage information processor 50 preferably includes all the databases 62 necessary to support the content updating functions of the present invention. However, it is contemplated that the usage information processor 50 can access any required database via communication networks 8, 16 or any other communication network to which the usage information processor 50 may be coupled.

In addition, the usage information processor 50 includes one or more modules that are preferably provided and used in accordance with the present invention. For example, the usage information processor 50 employs an area definition module 52, a significance association module 54, an area monitoring module 56, a change evaluation module 58, and an action determination module 60.

The area definition module 52 provides a convenient graphical user interface that includes controls for selecting and defining a portion of web site content in order to determine and evaluate changes in content. With the significance association module 54, the user associates relative values to represent the significant of any change that occurs in the defined areas. The decision of the action determination module 60 to take various forms of action can be dependent, at least in part, upon significance association module 54 and the area definition module 52.

The area monitoring module 56 detects changes in the content of the defined areas. In one embodiment, monitoring changes occurs regularly and/or automatically (or substantially automatically) according to the teachings herein. In an alternative embodiment of the present invention, the area monitoring module 56 is triggered manually, for example, when a user submits and order for formatted print pages and a check for changes in content occurs at that time.

After the present invention has employed the area monitoring module 56, the change evaluation module 58 determines whether changes in content in any area defined by the user have occurred. Preferably, some form of regression testing takes place as at least part of the evaluation. In a preferred embodiment, the change evaluation module 58 may make a comparison of hash totals, as described above. In an alternative embodiment, changes in specific locations on a server or other computer system where content is stored is evaluated, in the manner as described above. Alternatively, or in combination with other embodiments, an automated process, such as a software robot (“softbot” or “bot”) automatically establishes a communication session with a content provider and determines whether (and what kind) of changes are made to content, as described above. If content has changed, the change evaluation module 58 sets a dirty flag for each content item, which in turn indicates to the action determination module 60 what action should take place.

The action determination module 60 takes action in accordance with the meaning of the flag set by the change evaluation module 58. For example, a flag representing an significant change will trigger an update to an electronic file and/or database, such as a press-ready file. Conversely, a flag representing an insignificant change will not trigger an update to an electronic file and/or database, such as a press-ready file. In a preferred embodiment, after a change has been registered, the web site is automatically displayed so that the action determination module 60 can decide whether to take further action.

Thus, the present invention ensures that content used in formatted print pages is, among other things, current and provides updated formatted print pages.

Other uses and products provided by the present invention will be apparent to those skilled in the art.

Although the present invention has been described in relation to particular embodiments thereof, many other variations and other uses will be apparent to those skilled in the art. It is preferred, therefore, that the present invention be limited not by the specific disclosure herein, but only by the gist and scope of the disclosure.

We claim:

1. A method for using current content that is posted on a network comprising:
defining an area of content to be monitored;
associating a value of significance to the defined area;
monitoring the defined area to detect changes in the content;
evaluating the detected changes that occur in the defined area; and
determining if an action should be taken in response to the evaluation.

2. The method of claim 1, further comprising registering the significance of the change to the defined area.

3. The method of claim 1, further comprising defining a plurality of areas, and wherein the method is repeated for each of the plurality of areas.

4. The method of claim 1, wherein the determining if an action should be taken depends at least in part upon the associating a value of a change to the defined area.

5. The method of claim 1, wherein the monitoring the defined area and the evaluating the detected changes are automatic.

6. The method of claim 1, further comprising updating a press-ready file as the action.

7. The method of claim 1, further comprising providing formatted print pages as the action.

8. The method of claim 1, wherein the monitoring the defined area is performed by user request.

9. The method of claim 1, further comprising evaluating the detected changes with regression testing.

10. The method of claim 9, wherein the regression testing is a comparison of the current hash total against a previous hash total.

11. The method of claim 9, wherein the regression testing is a comparison of current storage locations against previous storage locations.

12. The method of claim 1, wherein the evaluating further comprises a comparison of text.

13. The method of claim 1, further comprising setting a flag in response to the evaluating the detected changes.

14. The method of claim 1, further comprising automatically displaying if change is detected.

15. A method for providing updated formatted print pages of electronically stored content that is current comprising:
defining an area of content to be monitored;
associating a value of significance to the defined area;
monitoring the defined area to detect changes in the content;
evaluating the detected changes that occur in the defined area; and
providing formatted print pages that are updated in response to the evaluation.

16. The method of claim 15, further comprising a user ordering the formatted print pages.

17. The method of claim 15, further comprising a user subscribing periodically to the formatted print pages.

18. The method of claim 15, wherein providing formatted print pages is automatic.

19. A system for using current content that is posted on a network comprising:
an area definition module that defines an area of content to be monitored;
a significance associating module that associates a value of significance to the defined area;
an area monitoring module that monitors the defined area to detect changes in the content;
an evaluation module that evaluates the detected changes that occur in the defined area; and
an action determination module that determines if an action should be taken in response to the evaluation.

20. The system of claim 19, further comprising updating a press-ready file.
